(19) United States
(12) Patent Application Publication
(10) Pub. No.: US 2008/0038077 A1
(43) Pub. Date: Feb. 14, 2008

(54) SELF-POLISHING AND TAPPING RIVET ASSEMBLY

(76) Inventor: A.L. Pepper Aasgaard, Omaha, NE (US)

Correspondence Address: MCKEE, VOORHEES & SEASE, P.L.C., 801 GRAND AVENUE, SUITE 3200, DES MOINES, IA, 50309-2721, US

(21) Appl. No.: 11/740,101

(22) Filed: Apr. 25, 2007

Related U.S. Application Data
(60) Provisional application No. 60/794,888, filed on Apr. 25, 2006.

(51) Int. Cl. F16B 19/04

(52) U.S. Cl. 411/29

(57) ABSTRACT

A self-tapping and self-polishing blind setting rivet assembly comprises a rivet body having a tubular sleeve and a flattened head. The rivet body surrounds a mandrel that may have a weakened area to allow detachment upon application of sufficient axial force to the shank. The axial force also sets the rivet by causing a tapered shoulder section of the mandrel to deform the rivet sleeve. The mandrel shank may be terminated in a screw tip. This screw tip punctures, spreads, self-taps, and self-polishes an aperture in the work pieces through which the rivet sleeve passes. The mandrel's shank may have a weakened area of reduced diameter adjacent to the screw tip that allows detachment of shaft following application of sufficient axial force to the shank. This application of force causes the tapered shoulder section of the screw tip to compress and deform the rivet sleeve setting the rivet.

### CROSS-REFERENCE TO RELATED APPLICATIONS

This application claims priority under 35 U.S.C. § 119 to provisional application Ser. No. 60/794,888 filed Apr. 25, 2006, herein incorporated by reference in its entirety.

The following related and commonly owned patents are incorporated herein by reference in their entirety: U.S. Pat. No. 6,796,759, issued Sep. 28, 2004; U.S. Pat. No. 6,904,831, issued Jun. 14, 2005; U.S. Pat. No. 5,741,099, issued Apr. 21, 1998; U.S. Pat. No. 5,762,456, issued Jun. 9, 1998; and, U.S. Pat. No. 5,915,901, issued Jun. 29, 1999.

### FIELD OF THE INVENTION

The present invention generally relates to the field of fasteners such as rivets and the like, and more particularly to self-tapping and self-polishing rivet assemblies used for joining work pieces, or the like.

### BACKGROUND OF THE INVENTION

Blind setting rivets are typically used to fasten sheet metal work pieces or the like together when access is available to only one side of the work pieces. However, application of blind setting rivets may at times be cumbersome. For example, in many applications, special jigs must be used to maintain exact alignment of the work pieces from the time the hole is drilled until the rivet can be applied.

Because of these and other limitations, self-drilling blind setting rivets were developed. These rivets employ specialized drill heads which may be difficult to manufacture and are thus prohibitively expensive for many applications. Further, such rivets may leave a burr on the outer layer of the work piece materials. This burr may prevent proper seating of the rivet and may cause fractures in work pieces as it is applied, resulting in a weak joint. Known to the art are self-drilling rivets having deburring ears to remove burrs during the drilling operation. However, the drill bit of such rivets removes work piece material to create a hole for the rivet shank. This removed material may fall within an enclosed area creating a possible nuisance or hazard.

Typical drills have spirals designed to help the metal edges cut and spiral the chips out. In a typical self-drilling rivet the spirals are designed to help the cut metal edges to create chips or burrs which requires that high torque be placed on the mandrel of the rivet assembly.

U.S. Pat. No. 5,915,901 describes the use of the excurvations formed during application to increase application strength. However, in some applications, a polished aperture is desirable. Consequently, it would be advantageous to provide a blind setting rivet that would be both self-tapping and self-polishing instead of only self-drilling (using a drill bit) or only self-tapping (using a screw tip). Such a self-tapping, self-polishing rivet would remove all excurvations that would leave a clean aperture. Additionally, a self-tapping and self-polishing rivet would be less expensive and easier to manufacture than the self-drilling rivets (using a drill bit) and would require less torque during application.

### BRIEF SUMMARY OF THE INVENTION

Therefore it is a primary object, feature, or advantage of the present invention to improve over the state of the art.

It is a further object, feature, or advantage of the present invention to provide a self-polishing and tapping rivet assembly that has all the advantages of a blind setting rivet.

Yet another object, feature, or advantage of the present invention is to provide a self-polishing and tapping rivet assembly wherein the rivet body surrounds a mandrel that has a weakened area or reduced diameter to allow detachment of the mandrel shaft upon application of sufficient axial force to the shank.

A further object, feature, or advantage of the present invention is to provide a self-polishing and tapping rivet assembly wherein axial force applied to the shank sets the rivet by causing a tapered shoulder section of the mandrel to deform the rivet sleeve.

Yet another object, feature, or advantage of the present invention is to provide a self-polishing and tapping rivet assembly wherein the mandrel shank may be terminated in the screw tip for puncturing, spreading, self-tapping, and self-polishing an aperture in the work piece through which the rivet sleeve passes.

One or more of these and/or other objects, features, or advantages of the present invention will become apparent from the specification and claims that follow.

According to one aspect of the present invention, a self-tapping and self-polishing blind setting rivet assembly for creating an aperture through two or more work pieces to thereby join the work pieces is disclosed. The rivet assembly has a mandrel having a shank. The rivet assembly also has an auger having a tip and an opposite shoulder portion operatively attached to the shank, a cutting portion with one or more cutting edges for cutting the aperture, a polishing portion with one or more polishing edges for polishing the aperture, and a generally longitudinal groove extending from the tip through the shoulder portion to channel cuttings away from the work pieces. The rivet assembly also has a rivet body having an enlarged flattened head and a hollow tubular sleeve for surrounding the mandrel and inserting into the aperture. In the preferred form, the shoulder portion is adapted to deform the hollow tubular sleeve upon application of sufficient axial force to the shank to thereby form a protuberant portion whereby the work pieces are compressed between the protuberant portion and the enlarged flattened head. The shank also has a weakened area of reduced diameter to thereby detach from the mandrel upon application of sufficient axial force to the shank. The shank also has a strengthened area of enlarged diameter spaced adjacent the shoulder portion to prevent the auger from separating from the hollow tubular sleeve upon detachment from the shank.

A new method for creating an aperture through two or more work pieces for joining the work pieces using a self-tapping and self-polishing blind setting rivet assembly is disclosed. The method includes providing a mandrel having a shank terminating in an auger having a cutting portion with one or more cutting edges and a polishing portion with one or more polishing edges. The method also includes sliding a rivet body having an enlarged flattened head and a hollow tubular sleeve over the shank, creating the aperture with the cutting edges on the cutting portion, polishing the aperture with the polishing edges on the polishing portion, inserting the hollow tubular sleeve into the aperture, protuberating the hollow tubular sleeve and joining the work pieces by applying sufficient axial force to the shank, and detaching the shank from the mandrel by applying sufficient axial force to the shank. In the preferred form, the method also includes the step of channeling material away from the work pieces using a generally longitudinal groove extending from a tip through an opposite shoulder portion on the auger, removing materials incrementally from the aperture with a staged leading cutting edge on the cutting portion for reducing stress on the shank, removing burrs from the aperture with a leading polishing edge on the polishing portion for reducing stress on the hollow tubular sleeve, and altering an angle of the cutting edges and the polishing edges relative to a longitudinal axis of the auger for controlling the rate of material remover from the aperture.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a side elevational view illustrating a self-tapping and self-polishing blind setting rivet assembly in accordance with an exemplary embodiment of the present invention;

FIG. 2 is a partial cross-sectional side elevational view illustrating the self-tapping and self-polishing blind setting bolt rivet assembly shown in FIG. 1;

FIG. 3 is a side elevational view illustrating the mandrel of the rivet assembly shown in FIG. 1;

FIG. 4 is a side elevational enlarged view illustrating the self-tapping and self-polishing auger of the mandrel shown in FIG. 3;

FIG. 5A and 5B are front elevational views further illustrating exemplary self-tapping and self-polishing augers in accordance with the present invention;

FIGS. 6A, 6B and 6C are side elevational views illustrating other self-tapping and self-polishing augers in accordance with exemplary embodiments of the present invention;

FIG. 7 is a partial cross-sectional side elevational view of the rivet assembly shown in FIG. 1 illustrating operation of the rivet assembly;

FIG. 8 is another partial cross-sectional side elevational view of the rivet assembly shown in FIG. 1 illustrating operation of the rivet assembly;

FIG. 9 is yet another partial cross-sectional side elevational view of the rivet assembly shown in FIG. 1 illustrating operation of the rivet assembly;

FIG. 10 is also a partial cross-sectional side elevational view of the rivet assembly shown in FIG. 1 illustrating operation of the rivet assembly;

FIG. 11 is a partial cross-sectional side elevational view illustrating operation of an alternative embodiment of the present invention;

FIG. 12 is a partial cross-sectional, side elevational view illustrating a self-tapping and self-polishing blind setting rivet assembly in accordance with another exemplary embodiment of the present invention;

FIG. 13 is a side elevational view illustrating the mandrel of the rivet assembly shown in FIG. 12;

FIG. 14 is a partial cross-sectional side elevational view illustrating a self-tapping and self-polishing blind setting bolt rivet assembly in accordance with an exemplary embodiment of the present invention;

FIG. 15 is a partial cross-sectional side elevational view illustrating another self-tapping and self-polishing blind setting bolt rivet assembly depicting with a threaded enlarged flattened head in accordance with an exemplary embodiment of the present invention;

FIG. 16 is a partial cross-sectional side elevational view illustrating a selftapping and self-polishing blind setting bolt rivet assembly in accordance with an exemplary embodiment of the present invention, wherein the bolt rivet assembly is shown following application; and

FIGS. 17A, 17B, 18A and 18B are side elevational views illustrating exemplary mandrels in accordance with an exemplary embodiment of the present invention.

FIG. 17A is a side elevation view illustrating a mandrel in accordance with an exemplary embodiment of the present invention;

FIG. 17B is an enlarged side elevation view of the auger of the mandrel shown in FIG. 17A;

FIG. 17C is an enlarged front elevation view of the auger of the mandrel shown in FIG. 17A;

FIG. 18A is a side elevation view illustrating another mandrel in accordance with an exemplary embodiment of the present invention;

FIG. 18B is an enlarged side elevation view of the auger of the mandrel shown in FIG. 18A; and

FIG. 18C is an enlarged front elevation view of the auger of the mandrel shown in FIG. 18A.

### DETAILED DESCRIPTION OF THE PREFERRED EMBODIMENT

Reference will now be made in detail to the presently preferred embodiments of the invention, examples of which are illustrated in the accompanying drawings.

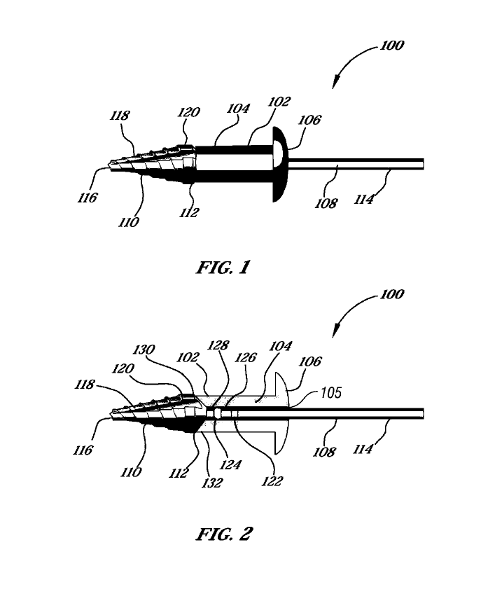

Referring generally now to FIGS. 1 through 11, a self-tapping and self-polishing, blind setting rivet assembly 100 in accordance with an exemplary embodiment of the present invention is described. As shown, rivet assembly 100 has a rivet body 102 with a hollow tubular rivet sleeve 104 and an enlarged flattened head 106 surrounding a mandrel 108 having a self-tapping and self-polishing auger 110, a shoulder section 112, and a shank 114. In exemplary embodiments, the rivet body 102 may be made of steel, aluminum, plastic, composite, or other desirable rivet material. The mandrel 108 may be made of steel, aluminum, plastic, composite, or other material, which is preferably of higher tensile strength than the rivet body material.

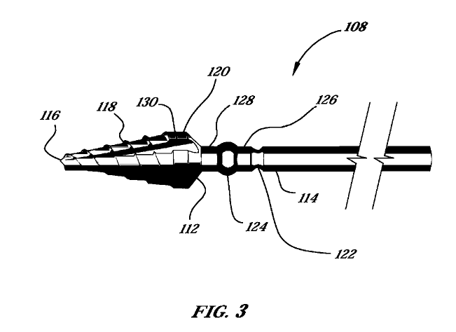

Self-tapping and self-polishing auger 110 is comprised of a generally conical barrel having a self-tapping and self-polishing tip 116, a cutting portion 118, and optionally a polishing portion 120. A weakened area of reduced diameter 122 may be formed in the mandrel shank 114 rearward from shoulder section 112. This weakened area 122 is preferably sized to fracture upon application of a predetermined tensile force to the shank 114 allowing self-tapping and polishing auger 110 and shoulder section 112 to be detached from shank 114 following completed application of the rivet assembly 100. Likewise, an area of enlarged diameter 124 may be formed in mandrel 108 between shoulder section 112 and weakened area of reduced diameter 122. This area of enlarged diameter 124 retains mandrel 108 within rivet body 102 until sufficient force is applied to the shank 114 during application to set the rivet body 102 and cause the area of reduced diameter 122 to fracture. In one embodiment, this enlarged area 124 also retains the self-tapping and polishing auger 110 and shoulder section 112 within sleeve 104 following application of the rivet assembly 100 by creating an interference with the inner surface 105 of the sleeve 104 as the sleeve 104 is deformed during application of the rivet. Moreover, in some embodiments of the invention, mandrel 108 may include a grommet or like seal for providing a liquid and gas impermeable seal between the shank 114 and the rivet body 102. As shown in FIGS. 2 and 3, lengths or spaces 126 & 128 of mandrel 108 may be provided between shoulder section 112 and enlarged portion 124 and between enlarged portion 124 and weakened area 122. However, in some applications these spaces 126 & 128 may be eliminated.

In other embodiments of the invention, weakened area 122 may be positioned on mandrel 108 so that a length of shank 114 remains in rivet body 102 after separation of the rear portion of the shank 114. Preferably, this length is predetermined to allow shank 114 to fracture at a point that is substantially flush with the outer surface of enlarged flattened head 106. In this manner, the remaining part of shank 114 substantially fills the hollow portion of the rivet body 102, increasing its strength.

It will be appreciated that the areas of reduced diameter 122 and enlarged diameter 124 may have different cross-sectional shapes depending upon factors such as, for example, the material from which the mandrel 108 is made, the types of work piece material(s) in which the rivet assembly 100 is being applied, the amount of fracture strength required for the area of reduced diameter 122, and the holding strength of the area of enlarged diameter 124. For instance, in FIGS. 2 and 3, the area of reduced diameter 122 and enlarged diameter 124 are shown as having generally curved cross-sectional shapes. However, in other embodiments, these areas may have a V-shape, a rectangular shape, a faceted shape, or the like.

During application of rivet assembly 100, self-tapping and polishing auger 110 is held substantially normal to the surface of a work piece while rotary motion is applied to shank 114. This rotary motion threads the auger 110 into the work piece materials and expands them. In this manner, the auger 110 pulls itself through the work piece materials while simultaneously smoothing the aperture it forms. Preferably, self-tapping and self-polishing tip 116 is pointed or angled to facilitate piercing of the outer surface of the work piece.

In other exemplary embodiments, the rear portion of the shank 114 may be designed for use with a specialized chuck or various types of power or hand tools to provide rotary motion and axial retraction to the mandrel 108. Preferably, the outer diameter 130 of shoulder section 112 is slightly larger than outer diameter 132 of rivet sleeve 104 allowing the sleeve to pass through the hole or aperture in the work piece materials formed by self-tapping and self-polishing rivet head 110.

Referring now to FIG. 4, the self-tapping and self-polishing auger 110 of mandrel 108 (shown in FIG. 3) is described. As described in the discussion of FIGS. 1 through 3, self-tapping and self-polishing auger 110 is comprised of a generally conical barrel having a self-tapping tip 116, a cutting portion 118, and optionally a polishing portion 120. In the embodiment illustrated in FIG. 4, self-tapping tip 116 includes a point 134 for piercing the surface of a work piece. Point 134, which may be centered on the longitudinal axis of auger 110 or offset therefrom, extends into one or more initial contact edges 136 suitable for forming a hole or aperture by puncturing, separating and then scraping or carving away work piece material. Initial contact edges 136 may be angled and may be offset to assist in separating and tapping the work piece material(s). In this manner, self-tapping and self-polishing tip 116 facilitates initial insertion (tapping) of the rivet assembly 100 allowing the rivet assembly 100 to be more easily started in the work piece.

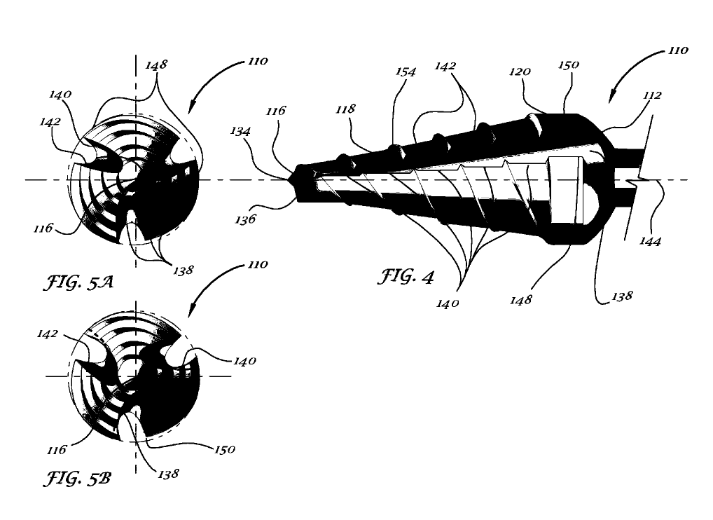

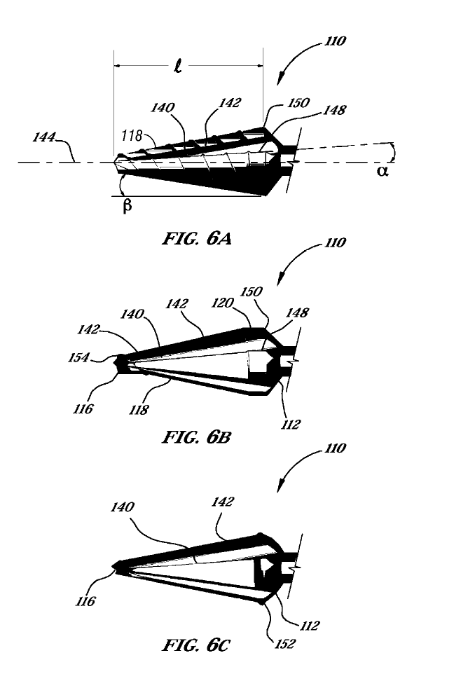

Also shown in FIG. 4 is a groove 138 formed generally longitudinally in the cutting portion 118 of auger 110. Groove 138 may extend to various depths in auger 110 and may have a variety of shapes depending on factors such as, for example, the type of material of the work piece for which the rivet assembly 100 (FIG. 1) is to be used (e.g., steel, aluminum, plastic, etc). For instance, groove 138 may have a generally half-conical shape extending from self-tapping and polishing tip 116 to shoulder section 112 so that the depth of groove 138 increases uniformly through cutting portion 118 as shown in FIGS. 4 and 5. However, it will be appreciated that groove 138 is not limited to this shape, but may have other shapes depending on the type of materials of the work pieces in which the rivet assembly 100 (FIG. 1) is being inserted, and the like. For example, in one embodiment, groove 138 may extend only partially from shoulder portion 112 of auger 110 to tip 116 while in another embodiment groove 138 may have a constant depth between tip 116 and shoulder portion 112 or may vary in depth or width in a non-uniform manner.

Staged leading cutting edges 140 and trailing edges 142 may be formed in the cutting portion 118 of self-tapping and self-polishing auger 110 along groove 138, rearward of self-tapping tip 116. Preferably, leading cutting edges 140 incrementally remove work piece material(s) by shaving or carving the materials from the wall of the aperture being formed. The removed materials may then be channeled away from the aperture by groove 138. In this manner, the amount of torque required for inserting or tapping rivet assembly 100 through a work piece is substantially reduced compared to conventional self-boring rivet assemblies.

As best illustrated by FIG. 4, leading cutting edges 140 and trailing edges 142 may be substantially parallel to the longitudinal axis 144 of self-tapping and self-polishing auger 110. Alternately, as shown FIG. 6A, any or all of leading cutting edges 140 and trailing edges 142 may be angled, thereby forming an angle (α) with respect to longitudinal axis 144. As shown in FIG. 4, leading cutting edges 140 and trailing edges 142 are generally parallel to longitudinal axis 144, angle (α) is substantially zero (0). Further, either or both of leading cutting edges 140 and/or trailing edges 142 may be curved.

A polishing leading edge 148 may be formed in the polishing portion 120 of self-tapping and self-polishing auger 110 along groove 138 rearward of cutting portion 118 and forward of shoulder portion 112. Similarly, a polishing trailing edge 150 may be formed in the polishing portion 120 along groove 138 opposite polishing leading edge 148. Preferably, polishing leading and trailing edges 148 & 150 remove any material excurvations (e.g., burrs or material removed from work piece by auger 110) leaving a clean, substantially burr free aperture formed in the work piece(s) through which rivet sleeve 104 (FIGS. 1 and 2) may pass. Further, either or both of polishing leading edge 148 and/or polishing trailing edge 150 may be curved.

In the exemplary embodiment shown, polishing leading edge 148 and polishing trailing edge 150 may be substantially parallel to the longitudinal axis 144 of auger 110. Alternately, as shown in FIG. 6A, either one or both of polishing leading edge 148 and polishing trailing edge 150 may be angled, thereby forming an angle (β) with respect to longitudinal axis 144.

By angling cutting edges 140, trailing edges 142, polishing leading edge 148 and/or polishing trailing edge 150, the amount of material removed during each turn of auger 110 may be controlled. Generally, by selecting a larger value of angle (α) for an auger having a given length (l), a smaller amount of work piece material is removed by each leading cutting edge 140. Likewise, by selecting a larger value of angle (β) for an auger 110 having a given length (l), a smaller amount work piece material is removed during each turn. Thus, it will be appreciated that the selection of angles (α) and (β) will depend on factors such as the application in which rivet assembly 100 is to be used and the material properties of the work pieces in which rivet assembly 100 is to be inserted, the amount of material to be removed by cutting and polishing edges 140 & 148, and the like. For example, in the embodiment shown in FIG. 4, wherein polishing edges 148 and polishing trailing edge 150 are generally parallel to longitudinal axis 144, angle (β) is substantially zero (0). Conversely, in the embodiment shown in FIG. 6A, polishing edges 148 & 150 are formed with an angle (β) equal to the taper of the cutting portion 118 of self-tapping and self-polishing auger 110. Accordingly, the polishing edges 148 & 150 shown in FIG. 4 would remove more material from the work piece(s) during each turn of auger 110 than the polishing edges shown in FIG. 6A.

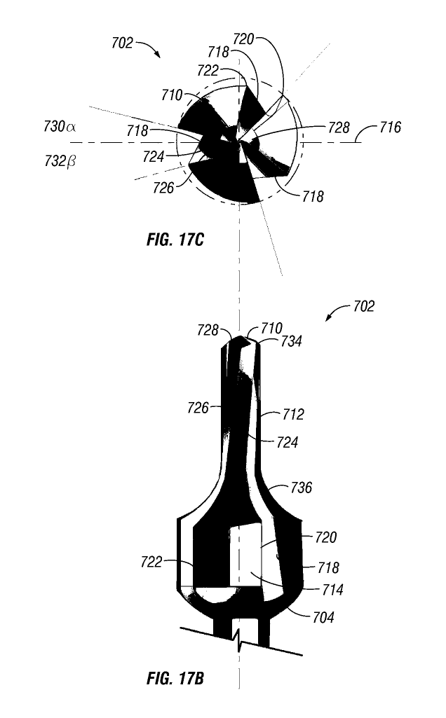

Referring now to FIGS. 5A and 5B, self-tapping and self-polishing auger 110 may include multiple grooves 138 and thus multiple sets of leading cutting edges 140 and trailing edges 142 spaced about its circumference. Moreover, leading cutting edge 140 may extend outwardly from longitudinal axis 144 (FIG. 4) further than trailing edge 142 depending on the application in which rivet assembly 100 is to be used, the material properties of the work pieces in which rivet assembly 100 is to be inserted, and the like. Similarly, polishing leading edge 148 may extend outwardly from longitudinal axis 144 (FIG. 4) further than polishing trailing edge 150. FIG. 5B illustrates an auger 110 wherein grooves 138 are angled with respect to the longitudinal axis 144 (FIG. 4) of the auger 110, while FIG. 5A illustrates an auger 110 wherein the grooves 138 are substantially straight (not angled). However, as shown in FIG. 17, the grooves may have a helical design thereby allowing the rapid spreading or distribution of filings from a fixed or constant source while cutting through a variety of material(s). The use of more grooves and additional cutting edges, coupled with other unique features identified herein, reduces the torque generated on the breaking point(s) or low area(s) of resistance applied to the mandrel stem while rotating allowing the self-tapping rivet mandrel, rivet body and cutting tip to cut through larger and/or harder materials without prematurely breaking. These features also facilitate heat distribution, minimizing friction, which allows the cutting tip to more efficiently slice through a greater range of materials.

Turning again to FIG. 4, threads 154 may extend substantially about the barrel of self-tapping and self-polishing auger 110. Threads 154 may extend between each leading cutting edge 140 and trailing edge 142 along the length of cutting portion 118, thus, separating each leading cutting edge 140 and trailing edge 142 from longitudinally adjacent leading cutting edges or trailing edges. Preferably, as auger 110 is inserted into a work piece, threads 154 pull the head through the work piece material, reducing the amount of force required to drive the head through the work piece. Shoulder section 112 may have a convex surface for providing less resistance to rivet sleeve 104 (FIG. 1).

In exemplary embodiment of the invention, polishing portion 120 may be tapered. Threads 154 may blend smoothly into polishing portion 120 or, alternately, shoulder section 112 to provide a smooth transition for polishing of the aperture formed. FIGS. 4, 5A, and 5B illustrate threads 154 as having a generally helical cone shape and extending between tip 116 and polishing portion 120. However, it will be appreciated that those of skill in the art may employ other thread designs without departing from the scope and spirit of the present invention. For example, the size and pitch of threads 154 may be varied, or the width or spacing of threads 154 may be increased or decreased as they progress along cutting portion 118 away from tip 116.

In the exemplary embodiments of the invention shown in FIGS. 6B and 6C, threads 154 may extend only partially along the length of the barrel of auger 110 from tip 116 to polishing portion 120 (as shown in FIG. 6B), or may be eliminated entirely (as shown in FIG. 6C) so that single leading cutting edges 140 and trailing edges 142 are formed. In FIG. 6C, polishing edges 148 & 150 (FIG. 4) are also eliminated so that leading cutting edges 140 and trailing edges 142 extend the length of auger 110 from tip 116 to shoulder portion 112. As shown in FIG. 6C, auger 110 may optionally include protruding finishing edges 152 which, in softer metals such as aluminum and the like, will function to remove any burr created by leading cutting edges 140 as the aperture in the work piece is formed.

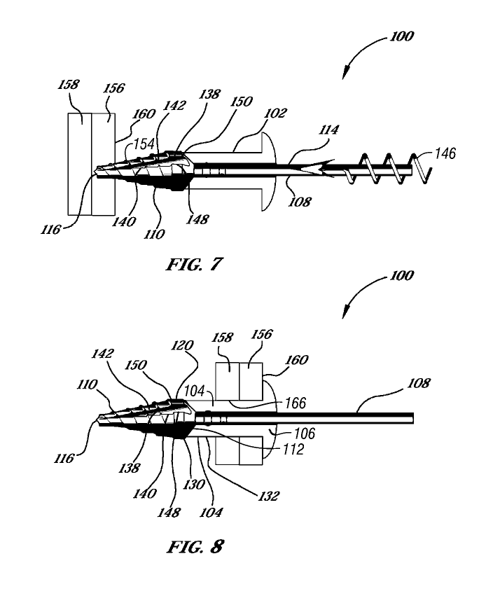

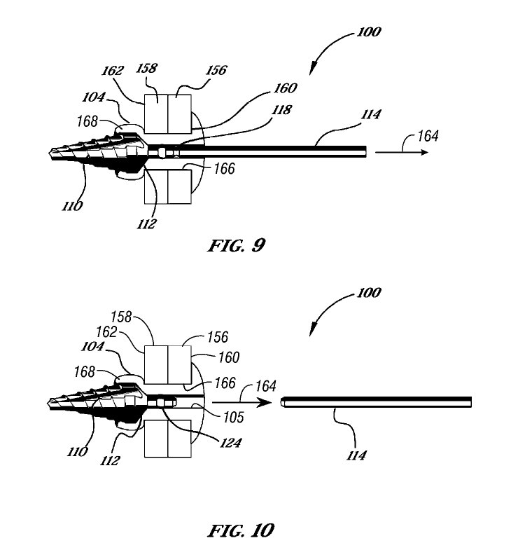

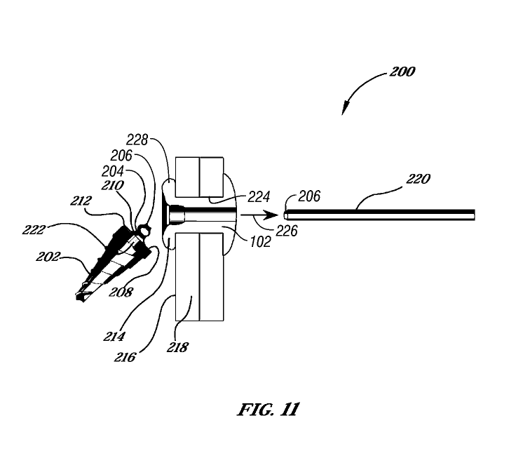

FIGS. 7 through 11 illustrate the application or insertion of a self-tapping and self polishing rivet assembly 10, described in connection with FIGS. 1 through 6, to join two or more work pieces (two work pieces 156 & 158 are shown). FIG. 7 depicts operation of the rivet assembly 100 near the beginning of application. Preferably, the self-tapping and self-polishing auger 110 is held substantially perpendicular to the outermost work piece surface 160 while rotary motion 146 is applied to the shank 114 of mandrel 108. For instance, as described in the discussion of FIGS. 1 through 3, the rear portion of the shank 114 may be placed in a specialized chuck (not shown) and various types of power or hand tools (not shown) may be used to provide rotary motion 146 and axial retraction 164 to the mandrel 108 (see FIGS. 9, 10 and 11).

Rotary motion 146 applied to mandrel 108 causes self-tapping tip 116 to tap a hole or aperture 166 (FIG. 8) in adjacent work pieces 156 & 158. As the self-tapping tip 116 punctures, spreads and cuts the work pieces 156 & 158, material on the outermost work piece surface 160, the outermost work piece 156 and innermost work piece 158 is separated and scraped or carved away. The rotary motion 146 of threads 154 on auger 110 further draws auger 110 into the work pieces 156 & 158, thereby pulling the auger 110 though the work pieces auger 156 & 158 where cutting edges 140 & 142 incrementally shave or carve material from the surface of the aperture 166 being formed. This removed material may then be channeled away from the aperture 166 via groove 138. In this manner, the amount of torque required to insert or tap auger 110 through a work piece is substantially reduced compared to that required by augers of conventional self-boring rivet assemblies. Further, the material removed by auger 110 may be more easily dispatched and kept from falling into places or remaining as unwanted residuals since it is channeled to the outermost work piece surface 160 of work piece 156.

FIG. 8 illustrates rivet assembly 100 following the creation of an aperture 166 through the work piece materials (156 & 158) by the self-tapping and self-polishing auger 110. As polishing portion 120 of auger 110 passes through the aperture 166 formed in work pieces 156 & 158, the rotary motion 146 (FIG. 7) applied to shank 114 further causes polishing edges 148 & 152 (FIG. 6C) to shave or carve additional material, such as burrs caused by leading cutting edges 140 and the like, from the inner surface of the aperture 166, thereby smoothing the aperture 166 prior to insertion of rivet sleeve 104. Preferably, the outer diameter 130 of the shoulder section 112 is slightly larger than outer diameter 132 of rivet sleeve 104 allowing the sleeve to pass through the aperture 166 formed. Once the aperture 166 is formed in work pieces 156 & 158, rivet sleeve 104 may be inserted into the aperture 166 until enlarged flattened head 106 abuts the outermost work piece surface 160 of the outer work piece 156.

FIG. 9 depicts axial retraction 164 of rivet assembly upon application of a rearward tension force on shank 114 for setting the rivet assembly 100. To set the rivet assembly 100, the rear portion of the shank 114 may be grasped by a riveting tool, a grasping tool, or the like, and axially retracted 164 away from the outermost work piece surface 160 of work piece 156. This axial retraction causes shoulder section 112 to deform rivet sleeve 104 to form protuberant portion 168. As shoulder section 112 (and self-tapping and self-polishing auger 110) is drawn into rivet sleeve 104, the tapered upper face of shoulder section 112 spreads the sleeve 104 radially to form protuberant portion 168. This action causes the rivet sleeve 104 to be spread to form protuberant portion 168 until it will no longer pass through the aperture 166 created in the work pieces 156 & 158. Further, the deformed portion of rivet sleeve 104 is pulled against the innermost work piece surface 162 of the innermost work piece 158 thereby tightening the rivet to the work pieces 152 & 154. Preferably, the weakened area of reduced diameter 118 is sized to break at a predetermined tensile load greater than the tensile load required to cause deformation of hollow tubular sleeve 104 to form protuberant portion 168, allowing the sleeve 104 to be fully deformed prior to separation of shank 114.

FIG. 10 depicts rivet assembly 100 following setting of the rivet assembly 100 and separation of shank 114. In the embodiment shown, self-tapping and self-polishing auger 110 and shoulder section 112 are retained in rivet sleeve 104 due to an interference between enlarged area 124 and the inner surface 105 of the sleeve 104. This interference may be created by deformation of the rivet sleeve 104 during application. In embodiments of the invention, the tapered upper face of shoulder section 112 may further deform the rivet sleeve 104 to at least partially encircle the auger 110 within the protuberated portion 168 to provide additional retention of the auger 110 after application of the rivet assembly 100.

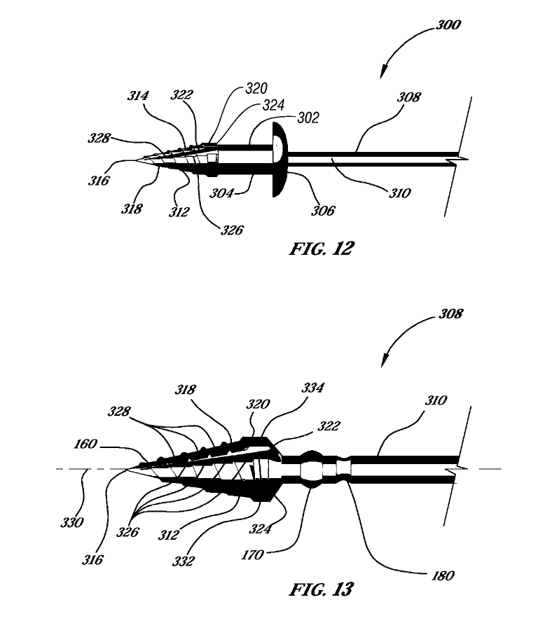

FIG. 11 illustrates a rivet assembly 200 in accordance with an alternative embodiment of the present invention wherein the self-tapping and self-polishing auger 202 and shoulder section 204 detach from the rivet body following axial retraction 226 of the shank 220. In such embodiments, wherein self-tapping and self-polishing auger 202 is allowed to drop off, the shoulder section 204 of mandrel 206 may have a face 208 comprising a tapered inner section 210 and a flat-plate outer section 212. Preferably, the tapered inner section 210 initially spreads the lower end of rivet sleeve 214 to form protuberate portion 228. The flat-plate outer section 212 then flattens the sleeve 214 against the innermost work piece surface 216 of the innermost work piece 218 allowing the self-tapping and self-polishing auger 202 and shoulder section 204 to drop off following separation of shank 220. Shoulder section 204 may further include etchings or serrations 222 about its perimeter for smoothing and polishing the aperture formed by auger 202.

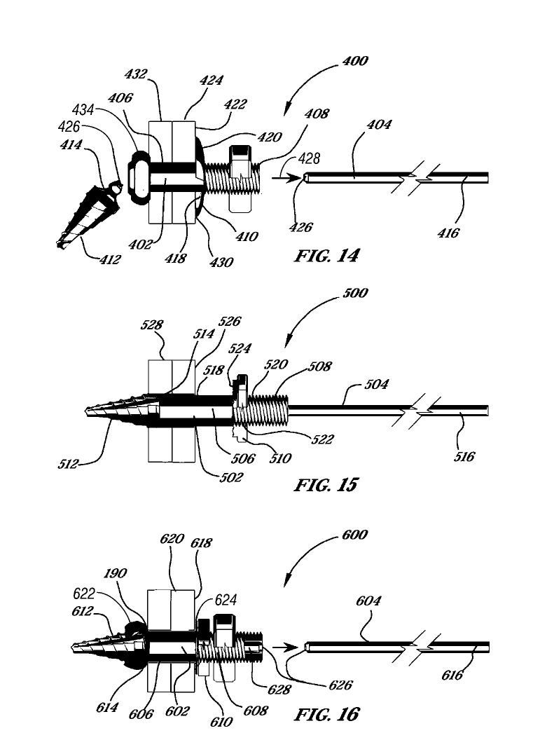

Referring now to FIGS. 12 and 13, a rivet assembly 300 employing a self-tapping and self-polishing auger in accordance with a second exemplary embodiment of the present invention is described. Rivet assembly 300 comprises a rivet body 302 having a hollow tubular rivet sleeve 304 and an enlarged flattened head 306 surrounding a mandrel 308 having a shank 310 with a self-tapping and self-polishing auger 312. The self-tapping and self-polishing auger 312 is comprised of a generally conical threaded barrel 314 having a self-tapping tip 316, a cutting portion 318, and optionally a polishing portion 320. In the embodiment illustrated, self-tapping tip 316 is pointed (i.e., it does not include initial contact edge 136 (FIG. 4) or has an initial contact edge 136 of nominal size) for forming or tapping an aperture in work piece by puncturing and separating work piece materials allowing the rivet assembly 300 to be more easily tapped or started in the work piece.

A groove 322 is formed generally longitudinally in the cutting portion 318 of barrel 314. Groove 322 may extend to various depths in barrel 314 and may have different shapes depending on the material of the work piece for which the rivet assembly 300 is designed. For example, as shown, groove 322 may have a generally V-shaped cross-section extending from self-tapping tip 316 to shoulder section 324 wherein the depth of groove 322 increases longitudinally along barrel 314 from tip 316 to shoulder section 324.

Staged leading cutting edges 326 and trailing edges 328 may be formed in the cutting portion 318 of auger 312 along groove 322, rearward of self-tapping tip 316. Like cutting edges 140 & 142 of FIGS. 1 through 5B, leading cutting edges 326 incrementally remove work piece material(s), which may then be channeled away by groove 322. In this manner, the amount of torque required to insert rivet assembly 300 through a work piece is substantially reduced compared to conventional self-boring rivet assemblies. Further, like cutting edges 140 of FIGS. 1 through 5B, leading cutting edges 326 and trailing cutting edges 328 may be substantially parallel to the longitudinal axis 330 of auger 312 or may be angled with respect to the longitudinal axis 330 depending on the application in which rivet assembly 300 is to be used, the material properties of the work pieces in which rivet assembly 300 is to be inserted, the amount of material to be removed by each cutting edge 326, and the like.

Similarly, polishing leading edge 332 and trailing edge 334 may be formed in the polishing portion 320 of self-tapping and self-polishing auger 312 along groove 322 rearward of cutting portion 318 and forward of shoulder portion 322. Like polishing edges 148 & 150 of FIGS. 1 through 5B, polishing leading and trailing edges 332 & 334 remove any excurvations (e.g., material removed from the work piece by auger 110) leaving a clean, substantially burr free, aperture through the work piece(s) through which rivet sleeve 304 may extend. Further, like polishing edges 148 & 150 of FIGS. 1 through 5, polishing edges 332 & 334 may be substantially parallel to longitudinal axis 330 or may be angled with respect to the longitudinal axis 330 depending on the application in which rivet assembly 300 is to be used, the material properties of the work pieces in which rivet assembly 300 is to be inserted, the amount of material to be removed by each polishing edge 332 & 334, and the like.

FIGS. 14 through 16 illustrate bolt rivet assemblies in accordance with exemplary embodiments of the present invention. The bolt rivet assemblies 400, 500 & 600 comprises a hollow rivet body 402, 502 & 602 surrounding a mandrel 404, 504 & 604, respectively. As shown, each of the rivet bodies 402, 502 & 602 includes a hollow tubular sleeve 406, 506 & 606 and a hollow threaded stud 408, 508 & 608 separated by an enlarged flattened head or flange 410, 510 & 610. The rivet body 402, 502 & 602 may be made of steel, aluminum, plastic, composite, or other desirable rivet material. The mandrel 404, 504 & 604 may comprise a self-tapping and self-polishing auger 412, 512 & 612 (e.g., auger 110 shown in FIGS. 4 and 5 or, alternately, auger 312 shown in FIGS. 12 and 13), a shoulder section 414, 514 & 614 and a shank 416, 516 & 616. The mandrel 404, 504 & 604 may be made of steel, aluminum, plastic composite, or other material that is preferably of higher tensile strength than the rivet body material.

In certain applications, it may be desirable for the threaded portion of bolt head 408, 508 & 608 to have multiple sets of threads. A separate bolt head may be fashioned so that these multiple threads may strip its internal threads as it is being threaded onto the rivet body 402, 502 & 602. Thus, once threaded onto the threaded portion, the bolt head cannot be removed. In this fashion, the bolt head may be tightened onto the rivet body and permanently retained. A second nut may be fashioned having a thread pattern corresponding to that of the rivet body so that it will not be stripped and consequently may be removable. Nuts suitable for use with bolt rivet assemblies 400, 500 & 600 may vary from six-sided or hex head nuts and wing nuts to various special shapes as required by the application. Additional work pieces, other components, or the like (not shown) may be removably attached to the hollow threaded stud and secured by the nut.

FIG. 14 depicts a rivet assembly 400 comprising a rivet body 402 including an enlarged flattened head 410 having a concave inner face 418 and convex outer face 420. Preferably, as the rivet assembly 400 is applied, axial retraction 428 of the mandrel 404 pulls the enlarged flattened head 410 against the outermost work piece surface 422 of the outermost work piece 424, compressing and flattening its concave inner face 418. When the reduced diameter 426 or alternatively a weakened area on mandrel 404 fractures and the shank 416 is released, the concave inner face 418 attempts to retain its original shape causing the rim 430 of the inner face 418 to apply a spring-like force to the outermost work piece surface 422. This force holds the work pieces (424 & 432) snugly between the enlarged flattened head 410 and deformed portion of the rivet body's sleeve 406. As a result, the enlarged flattened head 410 may increase application strength and prevent rotation of the rivet body 400 with or without a locking washer or serrated inner surface.

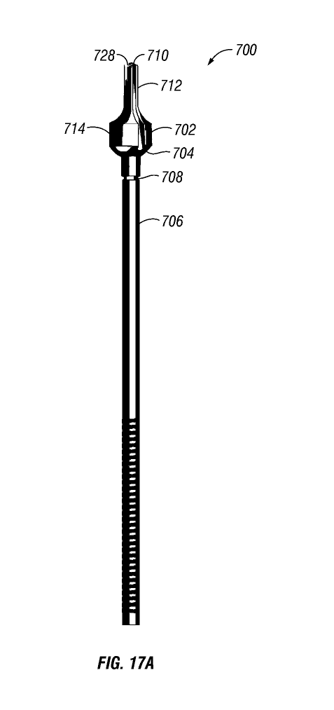

The head or flange of the rivet body 402, 502 & 602 may be part of a single piece rivet unit (e.g., enlarged flattened head 410) or it may be removable (e.g., removable heads 510 & 610). In FIG. 15, a rivet body 500 is depicted formed from a single tube 518 having a threaded portion 520 abutting the sleeve portion 506 and forming bolt head 508. Enlarged flattened head 510 includes a threaded aperture 522 so that it may be threaded onto threaded portion 520, and is thus removable. In exemplary embodiments, enlarged flattened head 510 may have a six-sided or hex design similar to a standard nut, or, may alternatively be cylindrical. Additionally, enlarged flattened head 510 may have serrated inner 524 (and outer) surfaces depending upon application requirements. These serrated surfaces 524 may function to increase surface friction between the enlarged flattened head 510 and the outermost work piece surface 526 of the innermost work piece 528 to prevent rotation of bolt rivet assembly 500 eliminating the need for a lock washer (FIG. 14). The serrated surfaces 524 may further function to prevent rotation of the bolt rivet assembly 500 during loosening and/or tightening of a nut onto the hollow threaded stud 508. Alternately, as shown in FIG. 16, a lock washer 616 may be utilized in place of serrated surfaces for preventing rotation of the rivet assembly 600 and removal of the head 608. Lock washer 616 may encircle rivet sleeve 606 and be trapped between the enlarged flattened head 610 and the outermost work piece surface 618 of outermost work piece 620.

In the embodiment shown in FIG. 16, weakened area or reduced diameter (diameter smaller than the diameter of the shank 616) 626 is positioned on mandrel 604 so that a length 628 of shank 616 remains in rivet body 602 after separation of the rear portion of the shank 616. Preferably, length 628 is predetermined to allow shank 616 to fracture at a point that is substantially flush with the end of bolt head 608. In this manner, the length 628 substantially fills the hollow portion of the rivet body 602, thereby increasing its strength.

FIGS. 1 through 16 illustrate augers designed to be rotated clockwise during insertion. However, it will be appreciated by those of skill in the art that the augers illustrated herein may alternately be designed to be rotated counterclockwise during insertion without departing from the scope and spirit of the present invention. Similarly, in FIGS. 14 though 16, bolt heads are shown having clockwise threads. However, bolt heads in accordance with the present invention may also be reverse threaded (i.e., may have counterclockwise threads). Additionally, bolt heads could be unthreaded, such as a bare post where a spring nut is used to keep the work pieces in compression.

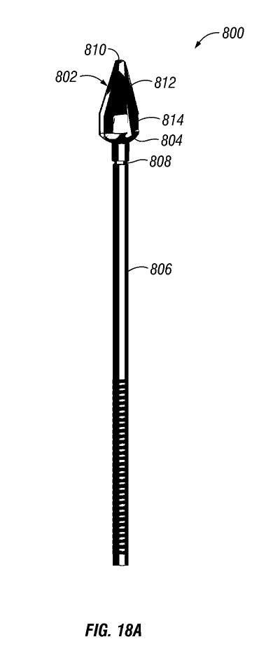

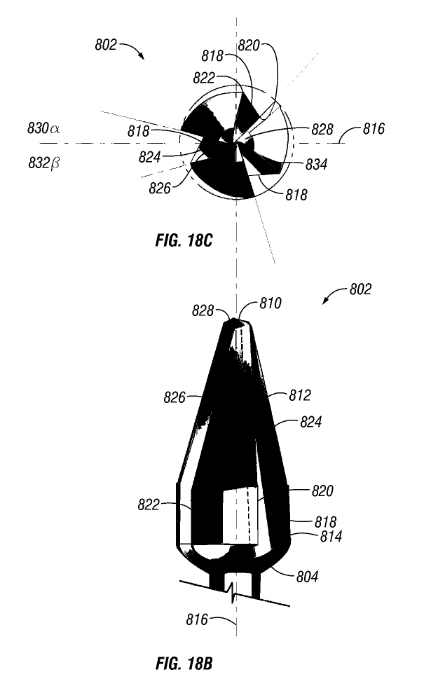

FIGS. 17A, 17B, 18A and 18B illustrate additional exemplary mandrels suitable for used by the rivet assemblies disclosed herein in accordance with an exemplary embodiment of the present invention.

FIG. 17A shows an alternative embodiment for a mandrel according to an exemplary embodiment of the present invention. Similar to the mandrel shown in FIG. 3, the mandrel illustrated in FIG. 17A has a self-tapping and self-polishing auger 702 that has a barrel with a constant diameter forward portion, a generally conical section and a constant diameter rearward portion. The barrel also has a self-tapping and self-polishing tip 728, a cutting portion 712, and optionally a polishing portion 714. A weakened area of reduced diameter 708 may be formed in the mandrel shank 706 rearward from the shoulder section 704. The weakened area of reduced diameter 708 is to facilitate separation of the shank 706 from the mandrel 700.

Referring now to FIG. 17B, the auger 702 of mandrel 700 (FIG. 17A) is described. As described in the discussion of FIG. 17A, self-tapping and self-polishing auger 702 is comprised of a generally constant diameter barrel having self-tapping tip 728, a cutting portion 712, and optionally a polishing portion 714. In one embodiment illustrated in FIG. 17B, self-tapping tip 728 includes a point 710 for piercing the surface of the work piece. The point 710 extends into initial contact edges 734 suitable for forming a hole or aperture by puncturing, separating, and then scraping or carving away work piece material. Initial contact edges 734 may be angled and may be offset to assist in separating and tapping the work piece material(s). In this manner, self-tapping and self-polishing tip 728 facilitates initial insertion (tapping) of the auger 702 allowing the auger 702 to be more easily started in the work piece. Also shown in FIG. 17B is a groove 718 formed generally longitudinally in the cutting portion 712 of the auger 702. Groove 718 may extend to various depths in the auger 702 and may have a variety of shapes depending on factors such as, for example, the type of material of the work piece. In the embodiment of the auger 702 shown in FIG. 17B, the groove 718 maintains a constant depth between tip 728 and shoulder portion 704. The pathway of the groove 718 is contoured to start on one plane and rotate several degrees so that the leading cutting edge 724 and trailing edge 726 formed in the cutting portion 712 are staged incrementally through radially progressing planes to remove work piece material(s) by shaving or carving the materials from the wall of the aperture being formed.

In the exemplary embodiment shown in FIG. 17B, the cutting portion 712 has a polishing portion 714 of the auger 702. The fluted portion 736 removes material from the aperture and further opens the aperture from the diameter of the forward portion of the cutting portion 712 to the diameter of the polishing portion 714. Also shown in FIG. 17B, the polishing leading edge 720 and trailing edge 722 are substantially parallel to axis 716 of auger 702.

As best illustrated by FIG. 17C, leading cutting edge 724 and trailing edge 726 may be angled, thereby forming an angle (α) and (β) with respect to axis 716. Thus, it will be appreciated that the selection of angles (α) and (β) will depend on factors such as the application in which the auger 702 is being used and the material properties of the work pieces in which the auger 702 is to be inserted, the amount of material to be removed by cutting and polishing edges 720 and 722, and the like.

Turning now to FIG. 18A illustrating an alternative embodiment of the mandrel 800. Similar to mandrel 700 shown in FIG. 17A, the mandrel 800 shown in FIG. 18A has a shank 806 and a weakened area of reduced diameter 808. The auger 802 has a shoulder section 804, a polishing portion 814, and a cutting portion 812 extending to the point 810 of the auger 802.

As best illustrated in FIG. 18B, the auger 802 has a generally conical cutting portion 812 extending from the tip 828 to the polishing portion 814. The auger 802 also has a groove 818 extending from the tip 828 through the cutting portion 812 and polishing portion 814 and ending at the shoulder portion 804. Each groove 818 forms on the cutting portion 812, a leading cutting edge 824, and a trailing edge 826. Similarly, each groove 818 extending through the polishing portion 814 terminates at a polishing leading edge 820 and a polishing trailing edge 822 on the outer surface of the polishing portion 814 of the auger 802.

As best illustrated in FIG. 18C, the auger 802 has a tip 828 formed by a point 810 and initial contact edges 834 to thereby facilitate initial insertion (tapping) of the auger 802 into the work piece. Similar to auger 702 shown in FIG. 17C, the auger 802 shown in FIG. 18C has a leading cutting edge 824 and trailing edge 826 on the cutting portion 812 of the auger 802. The leading cutting edge 824 and trailing edge 826 are angled, thereby forming an angle (α) and (β) with respect to axis 816. As previously discussed, it can be appreciated that the selection of angles (α) and (β) depend on many factors such as, for example, material properties of the work piece in which the auger 802 is to be inserted, the amount of material to be removed by the cutting and polishing edges 824 and 820, and the like.

It is believed that the self-polishing and tapping rivet assembly of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. A self-tapping and self-polishing blind setting rivet assembly for creating an aperture through two or more work pieces to thereby join the work pieces, the rivet
assembly comprises:
a mandrel having a shank;
an auger having a tip and an opposite shoulder portion operatively attached to the shank, a cutting portion with one or more cutting edges for cutting the aperture, a polishing portion with one or more polishing edges for polishing the aperture, and one or more generally longitudinal grooves extending from the tip through the shoulder portion to channel cuttings away from the work pieces; and
a rivet body having an enlarged flattened head and a hollow tubular sleeve for surrounding the mandrel and inserting into the aperture.

2. The rivet assembly of claim 1 wherein the shoulder portion is adapted to deform the hollow tubular sleeve upon application of sufficient axial force to the shank to thereby form a protuberant portion whereby the work pieces are compressed between the protuberant portion and the enlarged flattened head.

3. The rivet assembly of claim 1 wherein the shank further comprises a weakened area of reduced diameter to thereby detach from the mandrel upon application of sufficient axial force to the shank.

4. The rivet assembly of claim 1 wherein the shank further comprises an strengthened area of enlarged diameter spaced adjacent the shoulder portion to prevent the auger from separating from the hollow tubular sleeve upon detachment from the shank.

5. The rivet assembly of claim 1 wherein the tip is centered on a longitudinal axis for the auger and extends into one or more initial contact edges angled and/or offset from each other to thereby start and tap the auger into the work pieces.

6. The rivet assembly of claim 5 wherein the cutting and polishing edges further comprise a leading cutting edge or a leading polishing edge and a trailing edge, the leading cutting edge or the leading polishing edge being angled with respect to the longitudinal axis of the auger to thereby control the amount of material removed by each rotation of the auger.

7. The rivet assembly of claim 1 wherein the generally longitudinal groove has a generally half-conical shape extending from the tip through the shoulder portion at an increasingly uniform depth or constant depth.

8. The rivet assembly of claim 1 wherein the generally longitudinal groove is non-uniform in shape.

9. The rivet assembly of claim 1 wherein the generally longitudinal groove is configured with a helical design to thereby spiral from the tip through the shoulder portion with a varied depth and/or width.

10. The rivet assembly of claim 1 wherein the cutting and polishing edges are staged for incrementally removing material from the aperture.

11. The rivet assembly of claim 1 wherein the cutting portion further comprises a plurality of threads extending between the cutting edges to thereby pull the auger through the work pieces.

12. The rivet assembly of claim 11 wherein the plurality of threads have a generally helical cone shape and extend between the tip and polishing portion.

13. The rivet assembly of claim 1 wherein the enlarged flattened head further comprises a concave inner face and a convex outer face, the concave inner face being compressed against an outermost work piece surface to thereby urge the work pieces together.

14. The rivet assembly of claim 1 wherein the hollow tubular sleeve further comprises a threaded stud, the threaded stud for joining other work pieces or components to the rivet body.

15. The rivet assembly of claim 14 wherein the enlarged flattened head is separate from the hollow tubular sleeve and has threads for attaching to the threaded stud.

16. The rivet assembly of claim 15 wherein the mandrel detaches from the shank adjacent an outermost end of the threaded stud.

17. The rivet assembly of claim 1 wherein three generally longitudinal grooves extend from the tip through the shoulder portion of the auger.

18. The rivet assembly of claim 1 wherein more than three generally longitudinal grooves extend from the tip through the shoulder portion of the auger.

19. A method for creating an aperture through two or more work pieces for joining the work pieces using a self-tapping and self-polishing blind setting rivet assembly, the method comprising:
providing a mandrel having a shank terminating in an auger having a cutting portion with one or more cutting edges and a polishing portion with one or more polishing edges;
sliding a rivet body having an enlarged flattened head and a hollow tubular sleeve over the shank;
creating the aperture with the cutting edges on the cutting portion;
polishing the aperture with the polishing edges on the polishing portion;
inserting the hollow tubular sleeve into the aperture;
protuberating the hollow tubular sleeve and joining the work pieces by applying sufficient axial force to the shank; and
detaching the shank from the mandrel by applying sufficient axial force to the shank.

20. The method of claim 19 further comprising the step of channeling material away from the work pieces using a generally longitudinal groove extending from a tip through an opposite shoulder portion on the auger.

21. The method of claim 19 further comprising the step of tapering the shoulder portion for forming a protuberate portion on the hollow tubular sleeve.

22. The method of claim 21 further comprising the step of joining the work pieces between the protuberate portion and the enlarged flattened head.

23. The method of claim 19 further comprising the step of drawing the auger through the work pieces using a plurality of threads on the cutting portion.

24. The method of claim 19 further comprising the step of removing material incrementally from the aperture with a staged leading cutting edge on the cutting portion for reducing stress on the shank.

25. The method of claim 19 further comprising the step of removing burrs from the aperture with a leading polishing edge on the polishing portion for reducing stress on the hollow tubular sleeve.

26. The method of claim 19 further comprising the step of altering an angle of the cutting edges and the polishing edges relative to a longitudinal axis of the auger for controlling the rate of material removal from the aperture.

27. A self-tapping and self-polishing blind setting rivet assembly for creating an aperture through one or more work pieces to thereby join the work pieces and/or attach another work piece, the rivet assembly comprises:
a mandrel having a shank;
an auger having a tip and an opposite shoulder portion operatively attached to the shank; and
a rivet body having a hollow tubular sleeve, an enlarged flattened head, and a hollow threaded stud for surrounding the mandrel, the hollow tubular sleeve for inserting into the aperture.

28. The rivet assembly of claim 27 further comprises a threaded nut to thereby thread onto the hollow threaded stud for attaching another work piece or component to the rivet body.

29. The rivet assembly of claim 28 wherein the enlarged flattened head is threaded and together with the threaded nut is threaded onto the hollow threaded stud to thereby join the work pieces.

30. The rivet assembly of claim 27 wherein the rivet body is inserted into one work piece to thereby attach the other work piece to the hollow threaded stud.

31. The rivet assembly of claim 27 wherein the enlarged flattened head is threaded to thereby thread onto the hollow threaded stud to join the work pieces.

32. The rivet assembly of claim 27 wherein the auger detaches from the shank.

33. A method for creating an aperture through two or more work pieces for joining the work pieces using a self-tapping and self-polishing blind setting rivet assembly, the method comprising:
providing a mandrel having a shank terminating in an auger having a tip and an opposite shoulder portion;
sliding a rivet body having a hollow tubular sleeve, an enlarged flattened head, and a hollow threaded stud over the shank;
inserting the hollow tubular sleeve into the aperture;
protuberating the hollow tubular sleeve with the shoulder portion by applying sufficient axial force to the shank for joining the work pieces;
detaching the shank from the mandrel by applying sufficient axial force to the shank; and threading a threaded nut onto the hollow threaded stud for joining another work piece or component to the rivet body.

34. The method of claim 32 further comprising the step of releasing the auger from the rivet body upon detaching the shank by flattening the hollow tubular sleeve with a flat-plate outer section on the opposite shoulder portion.

35. The method of claim 32 further comprising the step of threading the enlarged flattened head onto the hollow threaded stud for compressing and joining the work pieces.

36. The method of claim 32 further comprising the step of removing material from the aperture in the work pieces with one or more grooves and one or more cutting edges on the auger.
